(19) United States
(12) Patent Application Publication
(10) Pub. No.: US 2008/0276318 A1
(43) Pub. Date: Nov. 6, 2008

(54) Spam detection system based on the method of delayed-verification on the purported responsible address of a message

(76) Inventors: Brian Leung, Kowloon (CN); Keith Lau, Kowloon (CN); Wah Cheong Hui, Kowloon (CN); Ching Shan Wong, Kowloon (CN)

Correspondence Address: ALIX YALE & RISTAS LLP, 750 MAIN STREET, SUITE 1400, HARTFORD, CT, 06103, US

(21) Appl. No.: 11/799,693

(22) Filed: May 2, 2007

(51) Int. Cl. G06F 11/30

(52) U.S. Cl. 726/23

(57) ABSTRACT

A spam detection system employs a “Delayed-Verification on Purported Responsible Address” (DVPRA) module which verifies the validity of the return address of a received e-mail message in mail server in a time delay interval specifiable by the user. An implementation of the module as a Spam Mail Filter in a stand-alone spam detection system. An implementation of the module as a supplementary to the existing anti-spam systems.

### BACKGROUND

The system relates to systems and methods that detect unsolicited massive e-mails (spam), and more particularly, the spam caused by the “hit and run” spam attack, that are unable to be detected and identified effectively using existing spam-detection methods.

### SUMMARY

While e-mail has become one of the most popular Internet applications, unsolicited massive e-mails (spam) created serious problems that affect its users and service providers tremendously, including reducing mail user's productivity, consuming storage of mail server, and wasting bandwidth of network.

There are different types of spam. The most notorious type, which is commonly known as “Spoofing”, is unsolicited commercial e-mail sent using forged sender addresses. In this type of spam, the true identity of the sender is concealed, and it is often used in phishing¹ attacks. As a result, a recipient will think a spam e-mail comes from a legitimate source, and may be tricked into opening the spam e-mail that is not from the trusted sender the e-mail purports to be from. ¹ Phishing refers to the activity in attempting to fraudulently acquire sensitive information, such as usernames, passwords and credit card details, by masquerading as a trustworthy entity in an electronic communication.

Another type of spam is the non-malicious junk e-mail, mostly consists of advertising of things that are worthless, deceptive, or fraudulent, such as pharmaceutical or sexually oriented spam.

There is also mischievous spam, such as those from someone who just simply enjoys annoying people.

Nowadays, numerous authentication methods have been developed and implemented by different email providers to combat spam by authenticating the source of inbound e-mail immediately upon receiving them. These include the IP-based approach such as Sender ID Framework proposed by Microsoft (www.microsoft.com/senderid), the cryptographic approach such as DomainKeys Verification supported by Yahoo (http://antispam.yahoo.com), and the pattern recognition approach such as Content-based Filtering.

While each of these methods is able to detect and filter particular kinds of spam in a real-time manner, none of these approaches can effectively eliminate all kinds of spam, and each of these approaches poses their own problems.

In the Sender ID Framework approach, the domains are required to publish their SPF (Sender Policy Framework) records to an open, centralized database. A SPF record specifies a certain number of IP addresses that are authorized to send legitimate e-mail messages originating from a company. Thus, by doing a table look-up, all the e-mails can then be authenticated by the inbound e-mail server by comparing the sender's IP address against the valid ones of the claimed domain from which the e-mail are authorized to originate.

However, this approach requires a centralized database maintained by a single party, and it requires service charges and other fees for the subscribers to use. And to some e-mail service providers this may portend a fall in network security level because of the disclosure of the valid domains' IP addresses.

The other authentication method, DomainKeys, involves digitally signing the messages. It is a system that attaches encrypted “keys” or tags to every e-mail sent, with one key held in a public database and another key, which is private, linked to the message. Once the message is delivered, the receiver could match up the private key to the public key held in the open database to verify the sender's identity. This enables the mail server and the receiver to confirm not only that a message came from a recognized server but that it was authorized by someone in the company and was not altered in transit. And if the public key cannot corroborate the signature, the message would be classified as spam.

Although this approach can also provide real-time spoofing detection, however, it has not been widely adopted and used in the industry. This slow adoption rate is partly because of concerns that digital signing might slow down the corporation's heavily used outbound mail servers. It may also involve installing additional plug-on software to the existing mail applications at user level, which may cause difficulties with average computer users with little knowledge in that area.

Another commonly used approach is the Content-based Filtering approach. In general, this approach uses heuristics filters, URL filters, signature filters, header filters and many more types of filters to determine if an-e-mail is a spam. While this approach is comparatively convenient to implement, however, someone can spoof the domain name so that the domain name is wrongly blacklisted, and the legitimate owner cannot send email to this mail server anymore.

Furthermore, this blacklist approach is reactive since spam can keep on changing the wording used in the email subject field and content, which makes it difficult to identify them in the first place.

Therefore, this approach is afflicted with false positives, which refer to e-mails that are wrongly identified as spam, and false negatives, which refer to spam which are regarded as normal e-mails.

As a result of the ineffectiveness of the existing methods in dealing with spam, these unsolicited e-mails have been proliferating in these years, as reviewed in a recent study that as many as 90.3% of e-mail received by an average user today are spam². ² SoftScan Newsletter—March 2007 (http://www.softscan.com)

In summary, although the prior art to combat spam e-mails has the advantage of detecting the spam in a real-time manner, it is confronted with problems of great proportion. These include problems such as slow adoption rate in the industry, false acceptance and rejection issues, and the concerns in network security in maintaining a centralized database for valid IP address look-up.

These and the other objects, features and advantages of the present invention will become apparent in light of the following detailed description of the preferred embodiments thereof, as illustrated in the accompanying drawings.

### BRIEF DESCRIPTION OF THE DRAWINGS

FIG. 1 is a block diagram illustration of the spam detection system based on the approach of Delayed-Verification on the Purported Responsible Address of a message.

### DETAILED DESCRIPTION

As discussed above, there are different kinds of spam. However, most of them share a common characteristic, i.e., most spam e-mail has forged the return address (i.e. the responsible address). The spam uses the “hit and run” tactics with fake sender name and with disposable, or forged, return address. The reason for that is obvious: no spammers would want their true identity to be traceable and verified. They cover their tracks by falsifying names and e-mail addresses in the mail sender field.

There are numerous ways for spammers to forge the return address of the spam. These include sending e-mail out directly from a computer with its own SMTP³ engine, rather than forwarding it via MAPI⁴ or via the mail server of the Internet Services Providers, and putting randomly generated fake address as the return address. Spammers can also use a technique called Relaying, in which they resort to re-routing their e-mail through third party e-mail servers, to conceal the source of the messages. Another common approach is to use disposable IP address as the return address, which is valid for only a short period of time, typically in a few hours, until the address is expired. ³ Simple Mail Transfer Protocol, a protocol for sending e-mail messages between servers. SMTP is generally used to send messages from a mail client to a mail server.⁴ Messaging Application Programming Interface, a system built into Microsoft Windows that enables different e-mail applications to work together to distribute mail.

As discussed previously, all the existing spam-detection methods mentioned above use immediate-verification approach. Although these methods are able to provide real-time results, however, these methods are not effective since they have not identified this “hit and run” characteristic, and are not designed to detect the spam based on this characteristic. And to most users, speed of e-mail delivery is not a priority when considering the problems and inconvenience caused by spam.

The present system thus makes use of the “hit and run” characteristic described above to detect the spam. And by allowing a time-delay in delivering the messages (which is user definable), the present system can achieve a result far more superior than the prior methods.

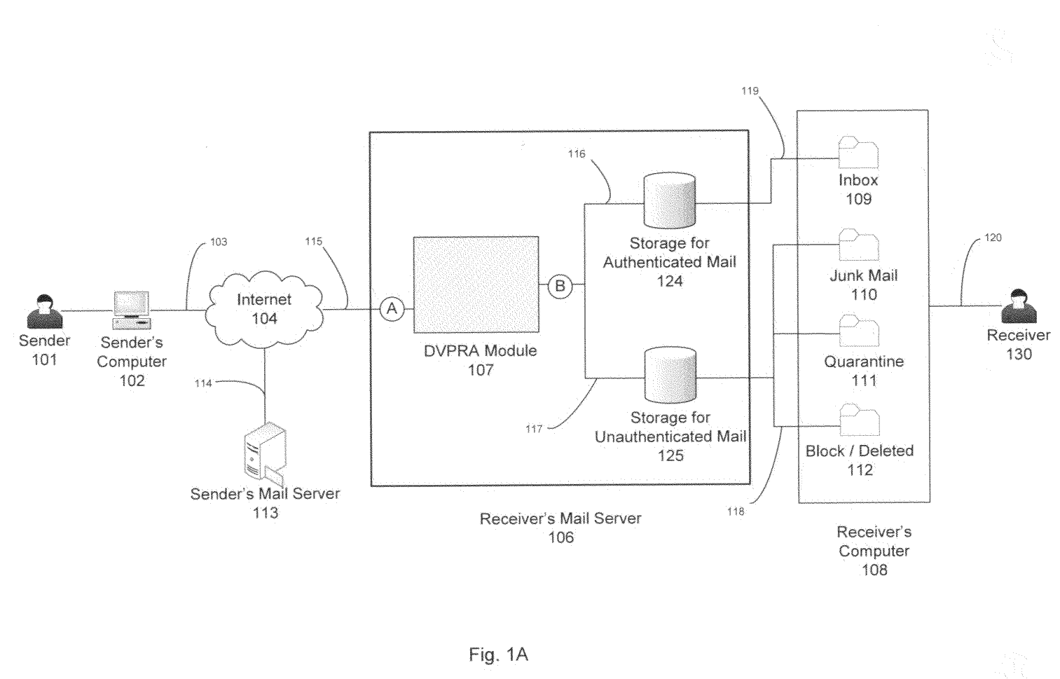

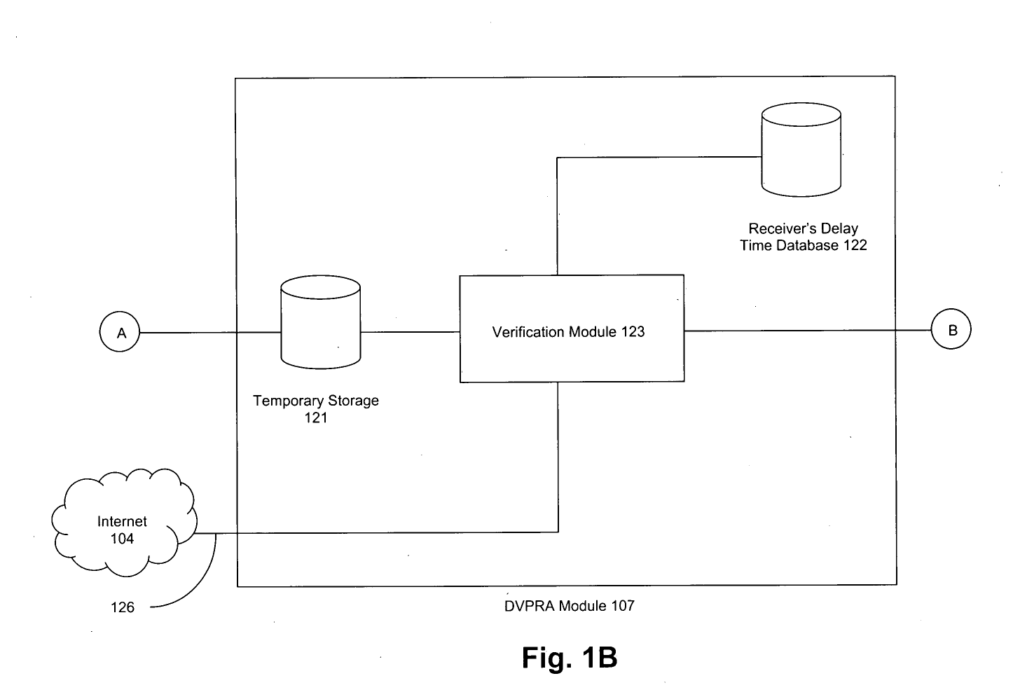

FIG. 1A is a block diagram of the DVPRA (Delayed-Verification on Purported Responsible Address) Module 107 layered over the Receiver's Mail Server 106. In this illustration, the DVPRA Module 107 is implemented as a software module installed in the Receiver's Mail Server 106, but the DVPRA Module 107 can also be implemented as hardware module installed as a separated machine linked to the Receiver's Mail Server 106.

In the block diagram, the Sender 101 transmits an e-mail message to the Receiver 130 using the Sender's Computer 102. The Sender's Computer 102 can be a Microsoft Windows machine, an Apple iMac machine, an Unix machine, or any machine that runs the standard SMTP email applications (such as Microsoft's Outlook Express), and it is platform-independent. The Sender's computer 102 is connected to the Internet 104 via the link 103. This link can be a broadband line, a dial-up line, or any other means.

Based on the standard SMTP specification, in a typical email transmission, when the Sender 101 composes an e-mail using the Sender's Computer 102 running a mail application, the e-mail will include a header with the information as follow:
From: sender@one-isp.com (My Name)
To: receiver@two-isp.com
Date: Sun, Mar. 18 2007 14:36:14 PST
X-Mailer: Microsoft Outlook Express 6.00.2900.2180
Subject: Hello

The Sender's Computer 102 will then transmit the message to the Sender's Mail Server 113, which will then transmit the message to the Receiver's Mail Server 106 via the Internet 104 according to the “To:” field in the email header, which can be mailhost.two-isp.com in this case as an example.

The message in the Receiver's Mail Server 106 will then undergo the authenticating procedure through the DVPRA Module 107. If the message is authenticated, it will be forwarded to and stored in the Storage for Authenticated Mail 124. Otherwise, it will be put to the Storage for Unauthenticated Mail 125. Eventually, upon receiving the request from the Receiver's Computer 108, these mails will be sent to the Receiver's Computer 108, and will be put to the Inbox 109, Junk Mailbox 110, Quarantine Mailbox 111, or will be blocked or deleted in 112 accordingly.

The DVPRA Module 107 is further illustrated in FIG. 1b. It uses the method “Delayed-Verification on Purported Responsible Address” to authenticate the message. When the Receiver's Mail Server 106 receives the message, it passes the message to the DVPRA Module 107, and the message is saved in the Temporary Storage 121, preferably a hard disk with enough capacity to store all the anticipated emails possible at a time. The Temporary Storage 121 will assign an ID number to the message, and pass the message header and the message ID to the Verification Module 123. At this point the message will sit in the Temporary Storage 121 and wait until receiving the retrieval request from the Verification Module 123.

After receiving the notification and the message header from the Temporary Storage 121, the Verification Module 123 will perform a table look-up against the Receiver's Delay-Time Database 122 for the delay time of the particular message receiver, which has been previously specified by the receiver.

Each receiver can specify her own delay time, or use the default setting specified by the service provider of the Receiver's Mail Server 106. This delay time can range from a few seconds to a few hours, depending on the receiver's preference for the detection strength level. The longer this delay time is set, the more effective this authentication method will become, and the trade-off would be the same delay in delivering the message to the receiver.

As previously discussed, the “hit and run” kind of spam is mostly done by using either randomly generated fake address or disposable IP address as the return address. A short delay time is good for identifying the first kind of spam that uses fake return address. A long delay time is more effective for detecting the spam that uses either the fake address or disposable IP address as the return address.

Once the delay time has elapsed, the Verification Module 123 will immediately proceed to verify the validity of the purported return address of the message, which is included in the message header passed by the Temporary Storage 121 at which the message is received. This is done by opening an Internet connection 126 to “port 25” of the mail server of the purported return address, and sending the SMTP commands to this mail server to verify the validity of the purported return address.

To do so, the Verification Module 123 will first search for the MX record of the purported return address by making an enquiry to the Domain Name System (DNS). A MX record, or Mail Exchanger Record, is an entry in DNS that specifies how Internet e-mail should be routed, and the entry contains the hostname mapped to a 32-bit IP address. Usually, the service provider of the Receiver's Mail Server 106 hosts their own DNS, and it is readily available for enquiry.

In the above example, if the purported return address of a message is sender@one-isp.com, the Verification Module 123 will search for the host and its 32-bit IP address in the DNS, which may be something like smtp.one-isp.com and 203.80.96.34 respectively.

After successfully getting the MX record, the module will then try to connect to the mail server based on the result of the MX record (i.e., 203.80.96.34 in the above example). If the connection is successful, the module will further request a SMTP response from the host for the purported sender, which is sender@one-isp.com in the above example.

The request will typically consist of the following SMTP commands:

| SMTP | |
|---|---|
| Command | Example & Description |
| HELO | HELO smtp.two-isp.com |
| | (to identify the Receiver's Mail Server 106) |
| MAIL | MAIL FROM: receiver@two-isp.com |
| FROM | (to initiate the request) |
| RCPT TO | RCPT TO: sender@one-isp.com |
| | (to specifies the purported return address. A successful |
| | response from the host indicates the address is valid.) |
| QUIT | QUIT |
| | (to terminates the connection) |

A successful response of the “RCPT TO” command above would be like this:
250 2.1.0 sender@one-isp.com . . . Recipient ok

A successful response indicates that the purported return address is a valid address, and the verification is considered successful. The Verification Module 123 will then retrieve the message from the Temporary Storage 121 by the message ID number assigned earlier by the Temporary Storage 121. The message will then be passed to the Storage for Authenticated Mail 124, which contains all the authenticated messages, and eventually to the Receiver's Computer 108 upon request by the Receiver 130.

On the other hand, if the verification has failed, the purported return address is considered invalid, and the message is considered spam. In this case, the message will be saved in the Storage for Unauthenticated Mail 125, and will be eventually passed to the Receiver's Computer 108, and saved in the Junk Mailbox 110, Quarantine Mailbox 111, or will be blocked or deleted in 112.

Once the response is received, the Verification Module 123 will immediately end the Internet connection 126 to the mail server of the purported return address by sending the QUIT command to that mail server. No message will actually be sent to the mail server, and the common SMTP command, DATA, is not used at all in this verification method.

The Storage for Authenticated Mail 124 and the Storage for Unauthenticated Mail 125 can be implemented in separated storage devices, or can preferably be implemented in the same storage device used by the Temporary Storage 121 to save the storage space. In the latter case, the messages will be classified into three groups, namely Pending, Authenticated and Unauthenticated, accordingly.

It will therefore be seen that we have developed a new spam detection system that implements the “Delayed-Verification on Purported Responsible Address” method, that allows the mail server to detect the “hit and run” kind of spam, that does not require additional plug-on software to the existing mail applications at user level, that does not require centralized database to store the spam blacklist, that does not involve any third-party licensing fee. Although the system may have a drawback of the short delay in delivering the message to the receivers, ranging from a few seconds to a few hours depending on the Delay Time specified by the receiver, the benefits of the system can easily offset this drawback.

The terms and expressions employed herein are used as terms of description and not of limitation, and there is no intention, in the use of such terms and expressions, of excluding any equivalent of the features shown and described or portions thereof, but it is recognized that various modifications are possible within the scope of the invention claimed. For example, in addition to implement the system as a stand-alone one as described, the system can also be implemented as a supplementary to an existing spam detection system.

In the block diagram, the DVPRA Module 107 is implemented within the Receiver's Mail Server 106. Alternatively, however, the DVPRA Module 107 can also be implemented as a hardware module installed as a separated machine, linked to the Receiver's Mail Server 106 via conventional network communication.

Furthermore, the delay time specified in the Delay Time Database 122 for the user can be set to zero. In this case, the DVPRA Module 107 will immediately verify the purported return address of the message, and no delay-time on message delivery would result.

Moreover, in the above case, the DVPRA Module 107 can optionally carry out the verification process in advance of the completion of receiving the whole message. When a message is to be authenticated under this verification-in-advance approach, after the Sender's Mail Server 113 has sent the SMTP command “RCPT TO” to the Receiver's Mail Server 106, the Receiver's Mail Server 106 will immediately verify the purported return address in a separated SMTP connection/session. The verification process should be the same as the one used in the DVPRA Module 107 discussed earlier.

In this case, if the purported return address is valid, the Receiver's Mail Server 106 will send back the SMTP response “250 2.1.0 sender@one-isp.com . . . Recipient ok” to the Sender's Mail Server 113, which will then continue to send the rest of the message. However, if the verification failed, the Receiver's Mail Server 106 will send back a different SMTP response, such as “550 5.1.1 User unknown”, to the Sender's Mail Server 113, indicating a SMTP session error and to stop any further data transmission from the Sender's Mail Server 113.

1. A first spam detection system that comprises a DVPRA Module that uses the “Delayed-Verification on Purported Responsible Address” approach to detect the “hit and run” kind of spam, which uses either randomly generated fake address or disposable IP address as the return wherein the return address will become invalid and untraceable after a short period of time ranging from seconds to hours.

2. The spam detection system described in claim 1, wherein the DVPRA Module enables the system to authenticate an incoming e-mail message in the receiver's mail server by verifying the validity of the purported return address.

3. The spam detection system described in claim 1, wherein the DVPRA Module enables the system to artificially postpone the verification of a message until a specified delay time.

4. The spam detection system described in claim 1, wherein the DVPRA Module allows the email receivers to specify their own delay time to verify the purported return address of the incoming e-mail, depending on their own preference for the a detection strength level.

5. The spam detection system described in claim 1, wherein the DVPRA Module can provide a default authentication delay time for all email receivers.

6. The spam detection system described in claim 1, wherein the DVPRA Module enables the system to detect the spam with fake return address by sending SMTP commands to the sender's mail server, and requesting a successful SMTP response from the mail server, to authenticate the sender address.

7. The spam detection system described in claim 1, wherein the DVPRA Module enables the system to detect the spam that uses disposable IP address as the return address, by delaying detecting the spam with fake return address by sending SMTP commands to the sender's mail server, and requesting a successful SMTP response from the mail server, to authenticate the sender address.

8. The spam detection system described in claim 1, further comprising a Temporary Storage module that enables the system to postpone verifying the purported return address of the incoming message at a later time, by temporary storing the message in the storage device.

9. The spam detection system described in claim 1, further comprising a Verifying Module that sends SMTP requests to the mail server of the purported return address of the message, instead of actually sending a complete e-mail, to determine whether the purported return address is valid or invalid.

10. The spam detection system described in claim 1, wherein the DVPRA Module allows users to perform immediate verification of all incoming messages by specifying the delay time described in claim 4 to zero.

11. The spam detection system described in claim 1, wherein the DVPRA Module can perform the verification on the purported return address of a message in advance, by verifying the return address immediately after receiving the SMTP command “RCPT TO” from the sender's mail server, and will send back the SMTP response that indicates session error and stop any further data transmission should the verification failed.
